(19) United States
(12) Patent Application Publication
(10) Pub. No.: US 2026/0270146 A1
(43) Pub. Date: Sep. 10, 2026

(54) Method for Integrating a Facility Component into a Communication Network of a Technical Facility

(71) Applicant: Siemens Aktiengesellschaft, Muenchen (DE)

(72) Inventors: Anna PALMIN, Karlsruhe (DE); Hans ASCHAUER, München (DE); Stefan BECKER, Adelsdorf (DE); Rainer FALK, Erding (DE); Christian Peter Feist, Grafrath (DE); Frank LAURIG, Sengenthal (DE)

(21) Appl. No.: 19/157,965

(22) PCT Filed: Feb. 5, 2024
(86) PCT No.: PCT/EP2024/052680

§ 371 Date: Aug. 19, 2025

(30) Foreign Application Priority Data
Feb. 20, 2023 (DE) 10 2023 201 458.0
Feb. 20, 2023 (EP) 23157621.6

(51) Int. Cl. H04L 41/08; G05B 19/418

(52) U.S. Cl. CPC H04L 41/0886; G05B 19/41845; G05B 19/4185

(57) ABSTRACT

A method for integrating a facility component into a communication network of a technical facility includes determining an integration service of the technical facility via the facility component, communicating information regarding integration method types supported by the facility component to the integration service of the technical facility, taking into account information available to the integration service of the technical facility regarding integration method types supported by the communication network of the technical facility, and information regarding integration method types supported by the facility component as communicated by the facility component, checking via the integration service whether an automated integration of the facility component into the communication network of the technical facility is possible, and implementing the integration of the facility component into the communication network of the technical facility when the automated integration of the facility component into the communication network of the technical facility is possible.

### CROSS-REFERENCE TO RELATED APPLICATIONS

This is a U.S. national stage of application No. PCT/EP2024/052680 filed 5 Feb. 2024. Priority is claimed on European Application No. 23157621.6 filed 29 Feb. 2023 and German Application No. 10 2023 201 458.0 filed 20 Feb. 2023, the content of which are incorporated herein by reference in their entirety.

### BACKGROUND OF THE INVENTION

### 1. Field of the Invention

The invention relates to a computer-implemented integration service, a computer-implemented tool and a method for integrating a facility component into a communication network of a technical facility.

### 2. Description of the Related Art

So-called “secure device onboarding” methods (for example, Bootstrapping Remote Secure Key Infrastructure (BRSKI)) are increasingly used on Operational Technology (OT) environments, in particular in line with the basic principle of zero trust “Never trust-always verify”. On the one hand, the corresponding methods enable proof of identity and/or proof of originality (see, for example, the requirement in International Electrotechnical Commission (IEC) 62443 “Provisioning product supplier roots of trust”). On the other hand, they enable secure provisioning of deployment-environment-specific credentials (for example, deployment-environment-specific certificates required for authentication with the associated cryptographic keys) to the OT devices.

Herein, secure zero-touch device onboarding methods have proven to be particularly desirable because they enable identity/originality verification and the provisioning of deployment-environment-specific credentials in a fully automated manner, i.e., without any user assistance, and are hence considered to be particularly user-friendly. Even the automatic identification of the entity (usually called a registrar) against which the identity/originality check is performed in the network and which is responsible for provisioning the aforementioned data to the device is fully automated within the framework of secure zero-touch onboarding methods, for example, using “automatic discovery mechanisms” (e.g., Multicast Domain Name System Protocol (mDNS), Generic Autonomic Signaling Protocol (GRASP)).

In some OT deployment environments, it is not only OT devices connected to the respective network that are to be provisioned with device-specific LDevID generic certificates within the framework of secure device onboarding or immediately thereafter, but also the applications hosted on the OT devices (for example, in docker containers). These correspondingly receive the required application-specific LDevID app certificates. Herein, this is referred to as the enrollment of application-specific certificates. This step is not a mandatory component of the known specifications, such as the aforementioned BRSKI specification. However, it has been proven to be useful and/or even necessary in many known OT deployment scenarios.

Due to dynamic customer requirements and equally dynamic requirements related to standardization/regulation, in future there will probably be OT devices that support more than one secure device onboarding method (i.e., at least two such methods). The OT deployment environments (for example, production plants and process engineering facilities) will also probably have to support a plurality of methods and this means that, for example, a BRSKI registrar and an Open Platform Communications Unified Architecture (OPC UA) registrar (according to OPC UA Part 21 “Device Provisioning”) will probably be available simultaneously in one environment in future.

An OT device that supports a plurality of secure device onboarding methods is deployed in an OT environment that likewise supports a plurality of secure device onboarding methods (by providing different registrars in this environment) currently has no information about which registrar it should specifically contact in the respective deployment environment, and which method suitable for this deployment environment (i.e., supported by this deployment environment) it should use. If an OT device does not support any of the secure device onboarding methods available in the respective deployment environment, then this should be detected as early as possible, inter alia, so that the most appropriate response can be made. At present, this is not possible in an automated manner.

U.S. Pat. No. 11,272,361 B1 discloses a method for integrating a technical component into a network.

WO 2022/028975 A1 discloses a system for verifying components of an industrial system.

EP 3 258 662 A1 discloses a method for registering an intelligent electrical device with a certification authority.

### SUMMARY OF THE INVENTION

It is an object of the invention to provide a method for integrating a facility component into a communication network of a technical facility that avoids the aforementioned disadvantages and enables more efficient and safer integration of the facility component.

This and other objects and advantages are achieved in accordance with the invention by a computer-implemented integration service, a computer-implemented tool and by a method for integrating a facility component into a communication network of a technical facility embodied as a process facility or production facility that comprises:
a) ascertaining an integration service of the technical facility by way of the facility component,
b) communicating information regarding integration method types supported by the facility component to the integration service of the technical facility,
c) taking into account information available to the integration service of the technical facility regarding integration method types supported by the communication network of the technical facility and the information regarding integration method types supported by the facility component as communicated by the facility component, and checking via the integration service whether automated integration of the facility component into the communication network of the technical facility is possible, and
d) in the event that automated integration of the facility component into the communication network of the technical facility is possible, integrating the facility component into the communication network of the technical facility, where in the context of the execution of the integration of the facility component, the following steps are executed:
i) communicating an integration plan from the integration service to the facility component, where the integration plan comprises information about which integration method type or which integration method types, if applicable in which order, are used in at least one integration step and which integration partner of the technical facility is used in each case, and where the integration plan comprises information about certificate profiles and/or key usage purposes that are to be taken into account when requesting certificates for the facility component for communication in the communication network, and
ii) automated execution of the integration step or the plurality of integration steps.

The technical facility is a facility from the process industry, such as a chemical, pharmaceutical, petrochemical facility or a facility from the food and beverage industry or a facility from the production industry, factories in which, for example, cars or goods of all kind are produced.

The facility component of the technical facility can be any device or a computer-implemented application that requires authentication by one or more certificates for communication with further components of the technical facility. Facility components of the technical facility can, for example, be apparatuses, such as pumps, valves, motors or boilers, but also software programs.

In contrast to conventional integration methods for facility components, both the integration method types available to the facility component and the integration method types available in the context of the communication network of the technical facility are taken into account. In accordance with the invention, an automated check is performed to determine whether an automated integration method for the (specific) facility component is possible in the context of the (specific) communication network of the technical facility. If the check is successful, i.e., if automated integration of the facility component into the communication network of the technical facility is possible, then this integration is executed automatically. Accordingly, there is no need to involve an operator or administrator of the technical facility.

When ascertaining the integration service, the facility component can use a discovery method that is known per se, such as a method based on Multicast Domain Name System Protocol (mDNS), GeneRic Autonomic Signaling Protocol (GRASP), Domain Name System (DNS) or Dynamic Host Configuration Protocol (DHCP). These methods are established in the IT world and can advantageously also be used in the field of communication within a technical facility.

The information that the facility component communicates to the integration service of the communication network of the technical facility can be in the form of a JavaScript Object Notation (JSON) file and/or as a security event message.

Preferably, the information additionally comprises at least one certificate management protocol supported by the facility component. This additional information can be used by the integration service for the subsequent integration of the facility component, as discussed in more detail subsequently.

A certificate is understood to mean a digital data record that confirms specific properties (in this case of machines, devices, applications and the like). The authenticity and integrity of the certificate can generally be verified via cryptographic methods. A certificate is issued by a certification authority, also known as an “issuing CA (certification authority)” for the use of a facility component in the technical facility. Such an issuing CA is generally always online and, based on incoming certificate requests, issues certificates for various applicants, which it signs with its own issuing CA certificate. The trustworthiness of the issuing CA is ensured by the fact that its own issuing CA certificate is signed by the certificate of a trusted root certification authority (also known as a “root CA”) located in a secure environment. It should be noted here that the root CA is offline most of the time and is only activated or switched on, in compliance with the most stringent safety requirements, when it is required to issue a certificate for an associated issuing CA. The root CA can be located outside the technical facility.

The certificate has a specific certificate profile. herein, the certificate profile comprises a certificate type. A type can, for example, be a TLS (Transport Layer Security) server certificate, a TLS client certificate, an OPC UA (Open Platform Communications Unified Architecture) server certificate or an OPC UA client certificate. Depending on the assigned certificate type and any further additional requirements, the certificate profile can comprise specific certificate attributes according to the ITU-T X.509 standard and their values. Herein, during validation based on this certificate profile, any certificate request that does not contain all the specified attributes and values is rejected. The more attributes and/or values are prescribed/specified by the certificate profile, the stricter and more accurate the validation.

In addition to secure communication, compliance with a secure device configuration in accordance with various security requirements, such as “security by default” and “least functionality”, is important for optimal protection of the technical facility. The facility component can be checked for originality in accordance with the security concept of the technical facility using the so-called manufacturer device certificates (IDevID Cert. in accordance with Institute of Electrical and Electronics Engineers (IEEE) standard 802.1AR).

The components of a technical facility generally communicate with more than one communication partner and herein use more than one secure communication protocol. For example, an industrial automation system (AS) can generally provide its web-based user interface for user access via Hypertext Transfer Protocol Secure (HTTPS) (using an associated Transport Layer Security (TLS) server certificate) and at the same time communicate with the associated OPC UA client via OPC UA (in the role of the OPC UA server). For this reason, the facility components should generally request a plurality of certificates (LDevID Cert.), where, from a security perspective, it is advisable to request or use a dedicated certificate for each intended use.

Since, generally, during its lifecycle, each certificate issued for a specific purpose is not only requested initially, but should/could also be renewed or revoked, the aforementioned Certificate Management Protocol (CMP) protocol, for example, offers various “CMP messages” that can be used to identify the respective type of certificate request (or the respective underlying use case). If, for example, the registration authority receives a so-called IR message (“initial request message”) from a facility component, it recognizes that this is an initial (first-time) request for a specific certificate. It recognizes a Key Update Request (KUR) or RR message as a request to renew or revoke an existing certificate.

Even if, from a purely technical perspective, all certificate types, such as TLS server, TLS client, OPC UA server or OPC UA client certificates, could be issued by the same certification authority (CA), for security reasons, it is recommended that they are separated and hence that a dedicated certification authority is used for each intended use or each communication protocol (e.g., TLS, or OPC UA). The reason for this is that, if a device uses a plurality of different certificates for different purposes or a plurality of communication protocols used by the device, which have been issued by the same certification authority and this certification authority is compromised, then the device can no longer communicate via a secure communication protocol, because its (only) certificate, which was issued and authenticated by a compromised certification authority, is therefore no longer considered trustworthy.

Even in the event that, according to the aforementioned recommendation, various certification authorities are used to issue certificates for different intended uses/communication protocols, the certificate request can generally be made via a (central) registration authority (RA). Herein, the registration authority can identify the intended use of the certificate in question, for example, based on the contents of the certificate request or based on the http/https path via which it receives the certificate request.

If an appropriate configuration has been made, then the registration authority can generally forward the various certificate requests to the various competent certification authorities. In this regard, it should be noted that, when using the CMP protocol, it is in principle possible for the facility components to specify the certification authority to be addressed in the “recipient” field. However, this requires them to “know” the various certification authorities and their assignment to the different certificate profiles, and this is rarely the case in practice. Normally, the facility components only know the registration authority (or in the case of segmented networks the competent local registration authority (LRA)) as the contact for certificate requests.

Particularly preferably, when contacted by the facility component, the integration service checks the identity of the facility component, in particular using identification information stored on the facility component by a manufacturer or integrator of the facility component according to the IEEE 802.1AR-2018 standard. This enables it to be ensured that the facility component cannot be integrated into the communication network of the technical facility without authorization.

Information regarding integration method types supported by the communication network of the technical facility may have been made available to the integration service in advance as part of the project planning for automation of the technical facility. However, this information may also have been made available to the integration service during the service life of the technical facility, for example, by an administrator of the communication network.

In the event that automated integration of the facility component into the communication network of the technical facility is not possible, preferably an operator of the technical facility is informed thereof, in particular by the generation of a corresponding message. The operator can then take appropriate measures and, for example, implement revised firmware on the facility component.

In the context of an advantageous embodiment of the invention, the integration service can check whether the automated integration has been executed correctly and, in the event of a successful check, release the facility component for communication in the communication network of the technical facility. This also enables it to be ensured that the integration has been carried out correctly.

In the context of the integration of the facility component, the following steps are executed:
i) communicating an integration plan from the integration service to the facility component, where the integration plan comprises information about which integration method type or which integration method types, if applicable in which order, are used in at least one integration step and which integration partner of the technical facility is used in each case,
ii) automated execution of the integration step or the plurality of integration steps.

Based on the information provided to it, the integration service creates an integration plan for the facility component. Herein, the integration plan contains at least information about which integration method type is to be used and which integration partner of the technical facility is to be used in each case. In the event that a plurality of integration method types is possible (the intersection between the integration method types supported by the facility components and those used by the communication network is greater than one), the integration plan can comprise prioritizing the integration method types. The integration plan can comprise a plurality of individual integration steps for which the integration method type and the associated integration partner of the communication network are defined in the integration plan in each case. The integration partner can, for example, be a “provisioning server”, a “secure device onboarding server” or a registrar such as the integration service.

Preferably, the integration service checks for at least one, preferably each, integration step whether it has been executed correctly. As a result, the integration service receives fine-grained feedback on whether the respective integration step was successful and, if necessary, can initiate adequate measures without further delay (for example, a corresponding message to an operator of the technical facility).

The check via the integration service can be performed based on a log of the integration method executed, where the log is created by the facility component as part of at least one, preferably each, integration step and transmitted to the integration service of the technical facility or stored so that it can be retrieved by the integration service. The integration service can communicate the log directly to the integration service or store it in a memory (for example, on the facility component itself) such that the integration service can retrieve the log immediately after the execution of the respective integration step.

The integration plan can comprise information about certificate profiles and/or key usage purposes that are to be taken into account when requesting certificates for the facility component for communication in the communication network.

The objects and advantages are also achieved in accordance with the invention by a method for virtual integration of a facility component intended for integration into a communication network of a technical facility as part of the project planning for automation of the technical facility via a project planning tool, where, taking account information regarding integration method types supported by the communication network of the technical facility and information regarding integration method types supported by the facility component, the project planning tool or a service commissioned by the project planning tool checks whether automated integration of the facility component into the communication network of the technical facility is possible.

In the context of this method, it is first checked whether automated integration of the facility component into the communication network of the technical facility is possible. This check is performed using a digital twin of the facility component. This digital twin functions like the real physical facility component and is provided by the project planning tool or a service commissioned thereby. In other words, the facility component is emulated. This emulated facility component can interact with the (actually implemented or also emulated) integration service of the communication network. The advantage of this method is that it can first be checked whether the facility component can be automatically integrated into the communication network of the technical facility.

In the event that automated integration of the facility component into the communication network of the technical facility is possible, the facility component can then be physically arranged in the technical facility and the facility component integrated into the communication network of the technical facility as explained above.

In the event that automated integration of the facility component into the communication network of the technical facility is not possible, the facility component intended for integration can first be virtually revised, in particular revised firmware can be virtually implemented on the facility component, where, after the virtual revision of the facility component, the method as explained above is executed again. In the event that automated integration of the facility component into the communication network of the technical facility is now possible, the facility component is also physically revised and arranged in the technical facility and the facility component is integrated into the communication network of the technical facility as explained above. A plurality of iterations is also possible in order to achieve compatibility for the automated integration of the facility component.

In addition, the object formulated above is also achieved by a computer-implemented registration service for a technical facility, which is configured to execute a method in accordance with disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which they are achieved will become clear and more plainly comprehensible in conjunction with the following description of the exemplary embodiment, which is explained in more detail in conjunction with the drawings, in which:

FIG. 1 is a schematic illustration of facility component that is intended to be integrated into a communication network of a technical facility embodied as a process facility; and

FIG. 2 is a flowchart of the method in accordance with the invention.

### DETAILED DESCRIPTION OF THE EXEMPLARY EMBODIMENTS

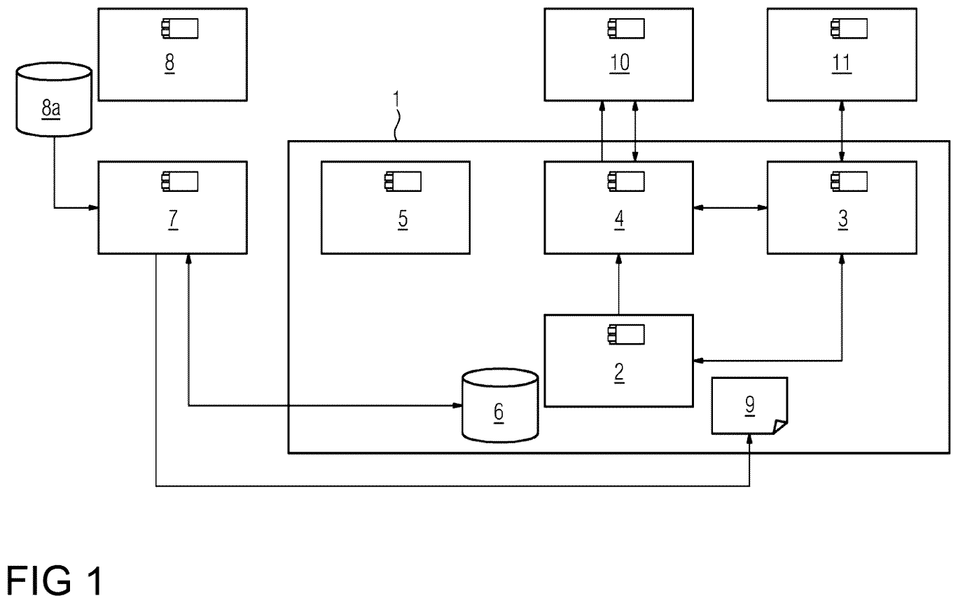

FIG. 1 schematically shows a facility component 1 that is intended to be integrated into a communication network of a technical facility formed as a process facility. The aim here is that the facility component 1 can, or is allowed to, communicate with further components of the technical facility via the communication network.

An integration wizard 2, a “CMP client” 3 according to the “Certificate Management Protocol”, a “BRSKI pledge” 4 according to the “Bootstrapping Remote Secure Key Infrastructure” protocol of the “IETF ANIMA” working group, and a “provisioning client” 5 according to the OPC UA (Open Platform Communications Unified Architecture) standard are computer-implemented in the facility component 1. Furthermore, the facility component 1 has a memory 6.

The following explains a sequence of an integration method: in the first step, the integration wizard 2 of the facility component 1 executes an automatic discovery method. This can, for example, be based on the Multicast Domain Name System Protocol (mDNS) or the GeneRic Autonomic Signaling Protocol (GRASP). The discovery method enables the integration wizard 2 of the facility component 1 to identify an integration service 7 of the technical facility.

The integration service 7 then first checks an identity of the facility component 1, in particular using identification information stored in the memory 6 of the facility component 1 by a manufacturer or integrator of the facility component 1 in accordance with the IEEE 802.1AR-2018 standard. Once the integration service 7 has determined the identity of the facility component 1, it allows data exchange between the facility component 1 and the integration service 7. This can, for example, occur using network access control in accordance with IEEE 802.1X, WLAN device authentication in accordance with IEEE 802.11 or a 5G-onboarding network access authentication in accordance with 3 GPP TS23.501 and TS33.501. Herein, the facility component 1 can authenticate itself via identification information in accordance with the IEEE 802.1AR-2018 standard, in particular via an IDevID device certificate. However, it is also possible for the facility component 1 to select a network access identifier (NAI) based on a serial number or based on a MAC address or based on an IMEI identity. In one embodiment, the permissibility of the identification information ascertained can be checked before data exchange between the facility component 1 and the integration service 7 is permitted. The integration wizard 2 of the facility component 1 then communicates information regarding integration method types and certificate management protocols supported by the facility component 1 to the integration service 7 of the technical facility, such as in the form of a JSON object. Further examples are an Extensible Markup Language (XML) object, a Concise Binary Object Representation (CBOR) object or an Abstract Syntax Notation One (ASN.1) object.

Taking into account information available from the integration service 7 of the technical facility regarding integration method types by the communication network of the technical facility and the information communicated by the facility component 1 regarding integration method types supported by the facility component 1, the integration service 7 checks whether automated integration of the facility component 1 into the communication network of the technical facility is possible. Automated integration is also referred to as “secure device onboarding”.

The integration service 7 obtains information regarding integration method types supported by the communication network of the technical facility supported from a computer-implemented tool 8, which, inter alia, is used to create project planning for automation of the technical facility. The computer-implemented tool 8 has a memory 8a in which the corresponding information is stored.

If the check establishes that the facility component 1 does not support any of the integration method types available in the respective deployment environment of the technical facility (secure device onboarding), then automated integration (secure device onboarding) is prevented. In addition, an operator of the technical facility is informed in an adequate manner (for example, by a corresponding message) that it is necessary to check the facility component 1 manually and to provision the necessary data to the facility component 1.

In the event that automated integration of the facility component 1 into the communication network of the technical facility is possible, the integration service 7 creates an integration plan 9 and communicates it to the integration wizard 2 of the facility component 1. The integration plan 9 comprises information about which integration method type or which integration method types, if applicable in which order, are used in at least one integration step and which integration partner of the technical facility is used in each case. In addition, the integration plan comprises information about certificate profiles and/or key usage purposes which are to be taken into account when requesting certificates for the facility component 1 for communication in the communication network. Herein, a certificate profile describes the essential contents/components of a specific certificate type and can, for example, take the form of a machine-readable XML file.

Examples of certificate profiles (for example, in the form of an XML file) are:
a device-specific locally significant device identifier generic certificate (sometimes also referred to as a customer device certificate),
various application-specific (also referred to as operational) certificates, such as a TLS client certificate, TLS server certificate, signing certificate, OPC UA client certificate, OPC UA server certificate.

Key usage purposes are, for example, “digital signature”, “key encipherment”, “key agreement”. These are standardized terms in accordance with RFC 5280 for the respective purpose for which the associated key (or the associated key pair, wherein the public key is contained in the certificate and the private is stored securely) may be used.

In the presently described exemplary embodiment, the “common denominator” of facility component 1 and the communication network is an integration method based on the BRSKI protocol. In the context of the integration method, the BRSKI pledge 4 executes an automatic discovery method based on the mDNS protocol to ascertain a BRSKI registrar 10 of the communication network. Alternatively, for example, direct contact with the BRSKI registrar 10 is also possible based on contact data contained in the integration plan 9. An LDeVID generic certificate is then issued using the BRSKI extension BRSKI-AE with the participation of the CMP client 3 in conjunction with a certification authority 11 of the technical facility for the facility component 1. Application-specific LDevID certificates are then issued with the cooperation of the CMP client 3 in conjunction with a certification authority 11 of the technical facility for the facility component 1.

These application-specific certificates use the individual services/applications of the facility component 1, such as an mutual transport layer security (MTLS) client for communication with partners within the communication network of the technical facility.

The integration service 7 monitors each integration step of the integration method using log data, which the integration wizard 2 stores in the memory 6 of the facility component 1. For this purpose, the integration service 7 has obtained corresponding access to the memory 6 of the facility component 1. Alternatively or additionally, the integration wizard 2 of the facility component 1 can generate a message for logging the respective integration step, which is communicated to the integration service 7 of the technical facility.

Alternatively or additionally, the messages generated (for example, via syslog) can be communicated to a central entity (e.g., a syslog server or a security information event management (SIEM) system which may evaluate the messages if necessary and/or make them available to other entities, such as the integration service and/or the user and may archive them for a specific period (for example 90 days) for the purpose of audits/traceability/forensics.

The aforementioned evaluation of the individual or multiple messages based on specific rules (possibly dynamically or AI-based configurable rules may trigger specific actions automatically or the user can be informed accordingly or prompted to take specific actions.

Following the successful execution of the integration plan, the facility component 1 is released for operational use in the communication network of the technical facility.

The integration method described can, for example, be used when the facility component 1 is initially commissioned in the technical facility. However, the method can also be used when a previous facility component is replaced by the current facility component 1. Herein, the information from the previous facility component 1 is transferred with the aid of the integration service 7, i.e., the integration plan created for the new current facility component 1 is based on the information and the original integration plan of the previous facility component 1 (which is, for example, stored in an archive accessible to the integration service 7).

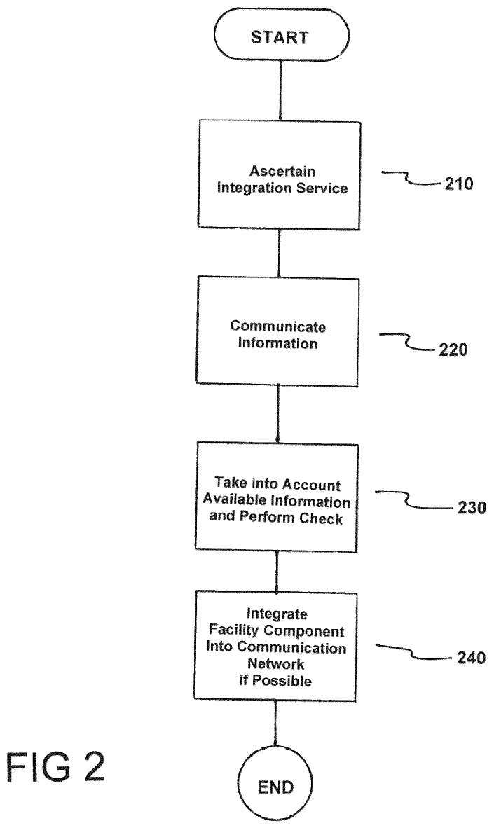

FIG. 2 is a flowchart of the method for integrating a facility component 1 into a communication network of a technical facility comprising a process facility or production facility.

The method comprises a) ascertaining an integration service 7 of the technical facility via the facility component 1, as indicated in step 210.

Next, b) information regarding integration method types supported by the facility component 1 is communicated to the integration service 7 of the technical facility via the facility component 1, as indicated in step 220.

Next, c) information available to the integration service 7 of the technical facility regarding integration method types supported by the communication network of the technical facility and the information regarding integration method types supported by the facility component 1 as communicated by the facility component 1 are taken into account, and a check is performed via the integration service 7 whether automated integration of the facility component 1 into the communication network of the technical facility is possible, as indicated in step 230.

Next, d) the facility component 1 is integrated into the communication network of the technical facility in the event of the automated integration of the facility component 1 into the communication network of the technical facility being possible, as indicated in step 240.

In the context of the execution of the integration of the facility component 1, the method includes i) communicating an integration plan from the integration service 7 to the facility component 1. Here, the integration plan comprises information about which integration method type or which integration method types, if applicable in which order, are used in at least one integration step and which integration partner of the technical facility is used in each case, and the integration plan further comprises information about at least one of certificate profiles and key usage purposes that are to be taken into account when requesting certificates for the facility component 1 for communication in the communication network. In addition, the method here includes ii) performing an automated execution of the integration step or the plurality of integration steps.

Although the invention has been illustrated and described in more detail by the preferred exemplary embodiments, the invention is not restricted by the disclosed examples and other variations can be derived therefrom by the person skilled in the art without departing from the scope of protection of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-17. (canceled)

18. A method for integrating a facility component into a communication network of a technical facility comprising a process facility or production facility, the method comprising:
a) ascertaining an integration service of the technical facility via the facility component;
b) communicating information regarding integration method types supported by the facility component to the integration service of the technical facility via the facility component);
c) taking into account information available to the integration service of the technical facility regarding integration method types supported by the communication network of the technical facility and the information regarding integration method types supported by the facility component as communicated by the facility component, and checking via the integration service whether automated integration of the facility component into the communication network of the technical facility is possible; and
d) integrating the facility component into the communication network of the technical facility in an event of the automated integration of the facility component into the communication network of the technical facility being possible, in a context of the execution of the integration of the facility component, the method includes:
i) communicating an integration plan from the integration service to the facility component, the integration plan comprising information about which integration method type or which integration method types, if applicable in which order, are used in at least one integration step and which integration partner of the technical facility is used in each case, and the integration plan further comprising information about at least one of certificate profiles and key usage purposes which are to be taken into account when requesting certificates for the facility component for communication in the communication network; and
ii) performing an automated execution of the integration step or the plurality of integration steps.

19. The method as claimed in claim 18, wherein the facility component utilizes an automatic discovery method to ascertain the integration service.

20. The method as claimed in claim 19, wherein the automatic discovery method comprises a method based on Multicast Domain Name System Protocol (mDNS), GeneRic Autonomic Signaling Protocol (GRASP), Domain Name System (DNS) or Dynamic Host Configuration Protocol (DHCP).

21. The method as claimed in claim 18, wherein the information according to step b) is communicated to the integration service of the facility component as at least one of (i) a Javascript Object Notation (JSON) file and (ii) a security event message.

22. The method as claimed in claim 19, wherein the information according to step b) is communicated to the integration service of the facility component as at least one of (i) a Javascript Object Notation (JSON) file and (ii) a security event message.

23. The method as claimed in claim 18, wherein the information communicated in step b) additionally comprises at least one certificate management protocol supported by the facility component.

24. The method as claimed in claim 18, wherein the integration service checks an identity of the facility component utilizing identification information stored on the facility component by a manufacturer or integrator of the facility component in accordance with Institute of Electrical and Electronics Engineers standard 802.1AR-2018.

25. The method as claimed in claim 18, wherein the information regarding integration method types supported by the communication network of the technical facility has been made available to the integration service in advance as part of the project planning for automation of the technical facility.

26. The method as claimed in claim 18, wherein, in the event that automated integration of the facility component into the communication network of the technical facility is not possible, an operator of the technical facility is informed thereof via generation of a corresponding message.

27. The method as claimed in claim 18, wherein the integration service checks whether the automated integration has been executed correctly and wherein, in the event of a successful check, the facility component is released for communication in the communication network of the technical facility.

28. The method as claimed in claim 18, wherein the integration service checks, for at least one integration step, whether the automated integration has been executed correctly.

29. The method as claimed in claim 28, wherein the integration service checks, for each integration step, whether the automated integration has been executed correctly.

30. The method as claimed in claim 28, wherein the check via the integration service is performed based on a log of the integration method which is executed; and wherein the log is created by the facility component as part of at least one, preferably each, integration step and transmitted to the integration service of the technical facility or stored such that the log is retrievable by the technical facility.

31. The method as claimed in claim 30, wherein the log is created by the facility component is part of each integration step.

32. A method for the virtual integration of a facility component intended for integration into a communication network of a technical facility comprising a process facility or production facility as part of the project planning for automation of the technical facility via a project planning tool;
wherein, taking into account information regarding integration method types supported by the communication network of the technical facility and information regarding integration method types supported by the facility component, the project planning tool or a service commissioned by the project planning tool checks whether automated integration of the facility component into the communication network of the technical facility is possible;
wherein, in the event that automated integration of the facility component into the communication network of the technical facility is possible, the facility component is physically arranged in the technical facility and the facility component is integrated into the communication network of the technical facility in accordance with claim 18.

33. The method as claimed in claim 32, wherein, in the event that automated integration of the facility component into the communication network of the technical facility is not possible, the facility component intended for integration is first virtually revised such that revised firmware is virtually implemented on the facility component;
wherein, after the virtual revision of the facility component, the method is re-executed; and
wherein in the event that automated integration of the facility component into the communication network of the technical facility is now possible, the facility component is also physically revised and arranged in the technical facility and the facility component is integrated into the communication network of the technical facility.

34. A computer-implemented integration service for a technical facility, which is configured to execute the method as claimed in claim 18.
